(19) United States
(12) Patent Application Publication
(10) Pub. No.: US 2015/0194080 A1
(43) Pub. Date: Jul. 9, 2015

(54) Magnet-Controlled Changeable Message Sign System and Method for Use Thereof

(71) Applicant: Scott L. Saunders, Bethel Park, PA (US)

(72) Inventor: Scott L. Saunders, Bethel Park, PA (US)

(21) Appl. No.: 14/504,040

(22) Filed: Oct. 1, 2014

Related U.S. Application Data
(60) Provisional application No. 61/923,467, filed on Jan. 3, 2014.

(51) Int. Cl. G09F 11/00

(52) U.S. Cl. CPC G09F 11/00

(57) ABSTRACT

A tamper-resistant sign system capable of providing patient indications and updating these indications using a magnet. The sign system comprises a support panel, a viewing panel with at least one viewing window, and at least one notification panel. The sign system comprises a means for creating a channel between the support panel and the viewing panel so that the display panel can slide in an out of the viewing window. Each display panel comprises at least one patient indication and may comprise a ferrous material. The sip system may comprise a magnet configured to move the display panel in or out of the viewing window. The present disclosure also provides for a method for providing a patient indication. The method may comprise moving a notification panel comprising at least one patient indication so as to be visible or not visible within a viewing window of a display device.

### RELATED APPLICATIONS

This Application claims priority under 35 U.S.C. §119(e) to pending U.S. Provisional Patent Application No. 61/923,467, entitled “Magnet-Controlled Changeable Message System,” filed on Jan. 3, 2014, which is hereby incorporated by reference in its entirety.

### BACKGROUND

Hospitals and other medical facilities display a variety of messages and warnings outside of patient rooms to inform staff and visitors about patient needs, restrictions, precautions, and other patient indications. For this information to be useful and trustworthy, it is important that this information is manipulated by only those individuals with the knowledge and authority to do so. There exists a need for a tamper-resistant, changeable sign system configured so as to allow for easy updating of patient information by authorized individuals while maintaining the integrity of the information.

### SUMMARY

The present disclosure provides for a tamper-resistant, changeable sign system which can be configured to provide information relating to at least one patient indication. The sign system described herein may utilize a magnet to manipulate internal panels which are encapsulated under a lens. By moving these panels, patient indications, in the form of symbols, colors, words, or phrases, can be made visible or not visible by an authorized user. While the panels can be seen, they cannot be manipulated without a magnet, thereby preventing any tampering with the display.

The sign system may comprise at least one support panel configured for affixing the sign system to a surface such as the wail outside of a patient's root or the patient's door. The sign system may also comprise at least one viewing panel, with at least one viewing window, and a means for defining at least one channel between the support panel and the viewing panel. The sign system may also comprise at least one notification panel, wherein each notification panel is configured to be movable within the channel so as to be visible or not visible within a viewing window. The sign system may also comprise a magnet configured for moving the display panel within the channel.

The present disclosure also provides for a method for providing at least one patient indication. A notification panel comprising at least one patient indication may be moved using a magnet so as to be visible or not visible within a viewing window of a sign system.

The sign system and method of the present disclosure overcomes the limitations of the prior art by providing a tamper-resistant message system that is also easily changeable. Using an external magnet to manipulate internal components of the display device, an authorized individual can easily update, add, remove, or otherwise change patient indications while maintaining the security of the device and preventing tampering by unauthorized individuals. Another advantage of the sign system and method of the present disclosure is that a user never has to touch the sign in order to manipulate it. This is advantageous in embodiments where the sign is used in a healthcare environment where there are infection-control concerns.

### BRIEF DESCRIPTION OF THE DRAWINGS

The accompanying drawings, which are included to provide further understanding of the disclosure and are incorporated in and constitute a part of this specification illustrate embodiments of the disclosure, and together with the description, serve to explain the principles of the disclosure.

In the drawings:

FIG. 1 is representative of a sign system of the present disclosure.

FIG. 2 is representative of a sign system of the present disclosure.

FIG. 3 is representative of a sign system of the present disclosure.

FIGS. 4A-4D are representative of a sign system of the present disclosure. FIG. 4A is representative of a sign system of the present disclosure comprising an external magnet. FIG. 4B is representative of a sign system of the present disclosure wherein an external magnet is affixed to the sign system. FIG. 4C is representative of a sign system of the present disclosure wherein a notification panel is moved using the magnet. FIG. 4D is representative of a sign system of the present disclosure wherein a patient indication is modified using a magnet.

FIG. 5A-5D are representative of a sign system of the present disclosure. FIG. 5A is representative of a sign system of the present disclosure comprising an external magnet and a rear docking station. FIG. 5B is representative of another view of a sign system of the present disclosure comprising an external magnet. FIG. 5C is representative of a magnet and carrier of a sign system of the present disclosure. FIG. 5D is representative of a magnet and carrier of a sign system of the present disclosure affixed to an identification badge.

### DETAILED DESCRIPTION

Reference will now be made in detail to the embodiments of the present disclosure, examples of which are illustrated in the accompanying drawings. Wherever possible, the same reference numbers will be used throughout the specification to refer to the same or like parts.

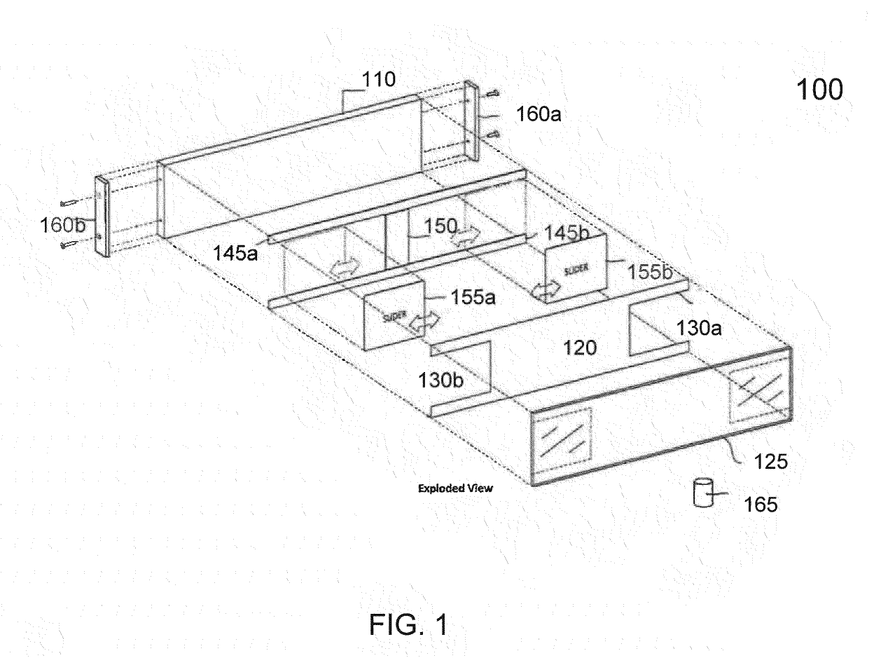

The present disclosure provides for a tamper-resistant sign system, one embodiment of which is illustrated in FIG. 1. The sign system 100 may comprise at least one support panel 110 configured for affixing the sign system 100 to a surface 185 such as a door or wall outside of a patient's door or another area within a hospital or other medical facility. The support panel 110 may comprise a variety of different materials, including but not limited to, a plastic, a metal, or any other suitable material. The present disclosure contemplates that a variety of different methods may be used to securely affix the support panel to a surface, including an adhesive or wall mount. One or more rigid spacers and/or double sided tape may also be used. The present disclosure is not limited one method for affixing the sign system 100 to a surface 185 and any method known in the art may be used.

The sign system 100 may further comprise at least one viewing panel 120 comprising one or more viewing windows 130a and 130b. In one embodiment, the various panels described herein may comprise a plastic, metal, or other suitable material. A lens 125 may be affixed to the viewing panel 120 to thereby encapsulate the sign system 100 and one or more side retainers 160a and 160b may be used to further secure the component pieces of the sign system 100. The number of viewing windows may depend on the number of different patient indications intended to be displayed by the sign system 100. For example, the viewing panel 120 may be configured so each viewing window 130a and 130b is associated with a different patient indication. Examples of patient indications may include, but are not limited to: a word, a phrase, a color, a symbol, and combinations thereof. Each patient indication may be further associated with a medical condition, a patient need, a restriction, a warning, or on information that would need to be conveyed.

Patient indications may be displayed by the sign system 100 by one or more notification panels 155a and 155b. These notification panels 155a and 155b may be configured so as to slide within one or more channels 140a and 140b defined between the support panel 110 and the viewing panel 120. The notification panels 155a and 155b may slide within the channels 140a and 140b so as to be visible or not visible within a viewing window 130a and 130b. In one embodiment the viewing panel 120 may comprise one or more opaque materials so that the patient indications on each notification panel 155a and 155b are not visible unless they are slid within the associated viewing window 130a and 130b. The channels 140a and 140b may be defined using a variety of different mechanisms including various vertical spacers 145a and 145b and/or horizontal spacers 150. In one embodiment, these spacers 145a, 145b, and 150 may comprise an aluminum material. In another embodiment, they may comprise another metal, plastic or other suitable material. If each notification panel 155a and 155b is configured so as to display one patient indication, the number of channels of the display device 100 may depend on the number of different patient indications indented to be displayed by the sign system 100.

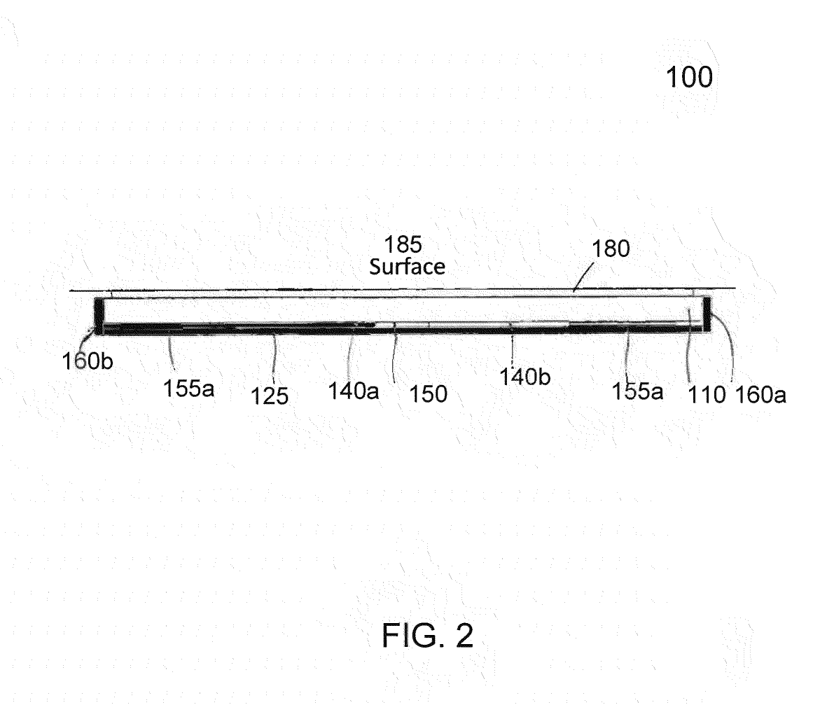

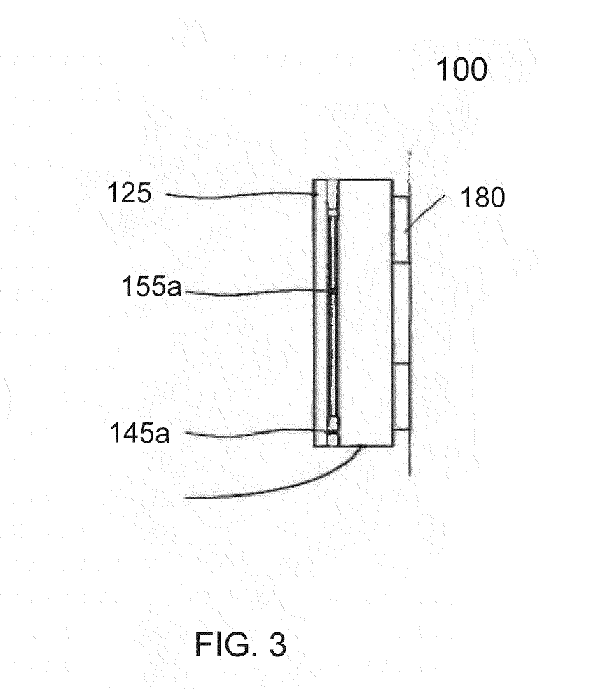

FIG. 2 and FIG. 3 are provided to illustrate various views of the sign system 100. As can be seen from FIG. 2, which illustrates a top view of the sign system 100, a support panel 110 may be affixed to a surface 185 using one or more mechanisms 180. One or more vertical spacers 150 may be used to define channels 140a and 140b. Horizontal spacers may also be used to define the channels 140a and 140b (not illustrated in FIG. 2). FIG. 3, which illustrates a side view of the sign system 100, clearly illustrates the use of these horizontal spacers 145a and 145b. Notification panels 155a and 155b may slide within the channels 140a and 140b so as to move in or out of viewing windows 130a and 130b of the viewing panel 120. A lens 125 is affixed to the viewing panel 120 thereby encapsulating the sign system 100 and side retainers 160a and 160b may secure the various components.

In one embodiment, the sign system 100 may further be configured so as to be tamper-resistant. Referring again to FIG. 1, the sign system 100 may be configured so that the various notification panels 155a and 155b comprise at least one ferrous material and are manipulated so as to slide in or out of a viewing window 130a and 130h using a magnet 165.

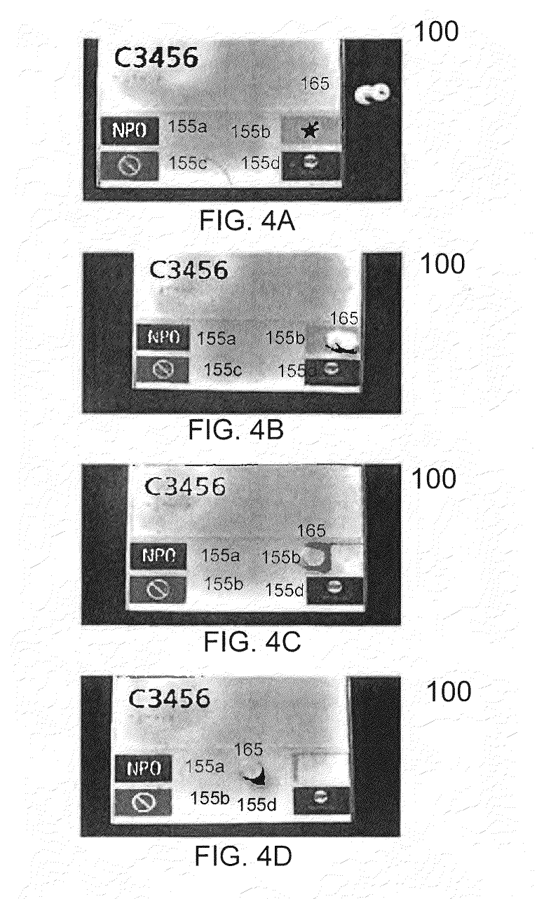

In one embodiment, illustrated by FIGS. 4A-4D, the magnet 165 may be affixed to the front of the sign system 100 for easy manipulation of the various notification panels 155a-155d. In FIG. 4A, various patient indications are displayed via four notification panels 155a-155d. In FIG. 4B, the magnet 165 may he affixed to one notification panel 155a that needs to be changed or modified. In FIG. 4C, the notification panel 155b is slid horizontally so as to not be visible within the associated viewing window. The result, illustrated in FIG. 4D is that the patient indication has be changed.

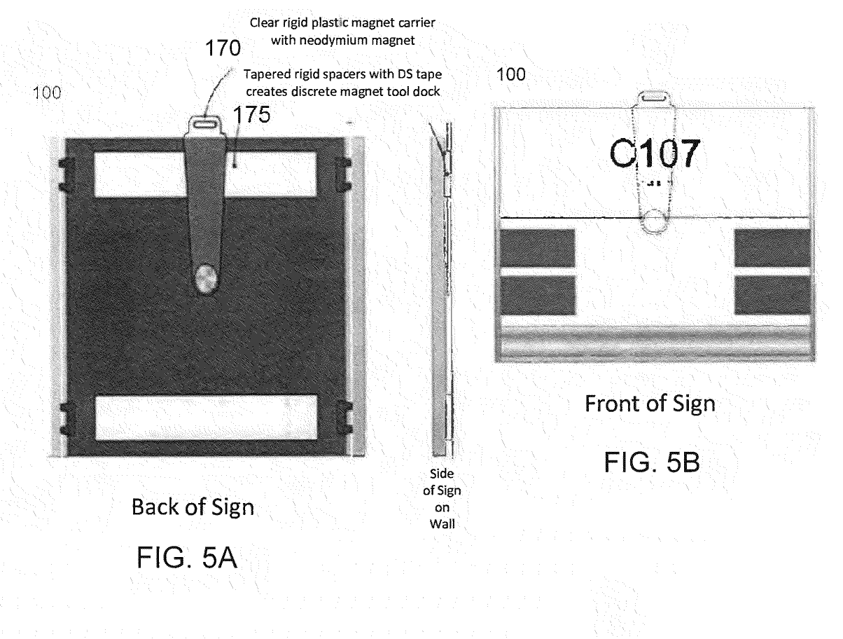

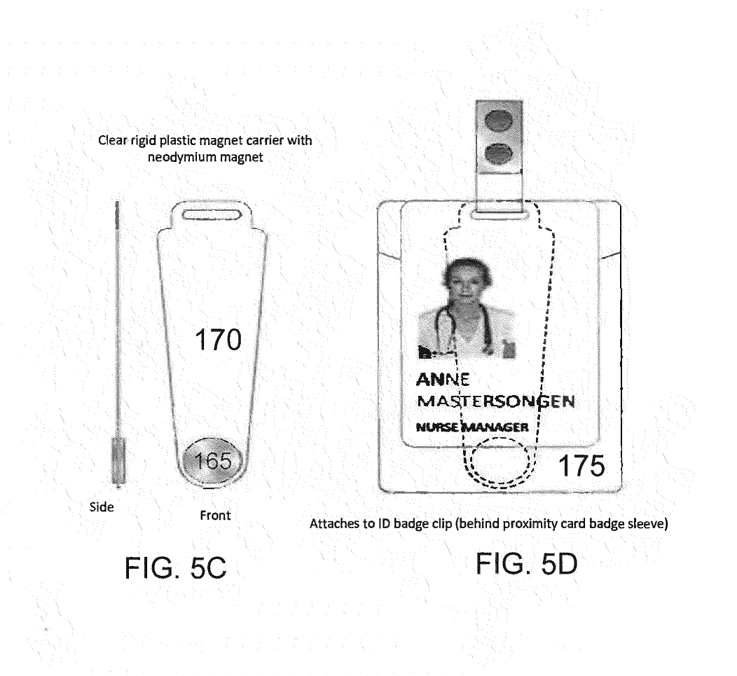

In another embodiment, illustrated by FIGS. 5A-5D, the magnet 165 may be housed within a carrier 170 and inserted into a docketing station 175 in sign system 100. In such an embodiment, the sign system 100 may further comprise one or more mechanisms for affixed to the support panel 110 and configured so as to define one or more channels 175. These mechanisms may be used to both affix the support panel 110 to a surface 185 and also define the channels 175. As discussed herein, the mechanism may comprise one or more rigid spacers, double sided tape, and/or any other suitable mechanism known in the art. In one embodiment, one or more rigid spacers may be configured with low-profile double sided tape on both sides of the spacers. The channel 175 may also be referred to as a “docking station” for a magnet 165.

While the figures of the present disclosure illustrate the docking station 175 to be configured external to the sign system 100, the present disclosure also contemplates that different embodiments of the sign system 100 may comprise an internal docking station 175. In addition, while FIG. 5 illustrates the docking station 175 to be located at the back of the sign system 100, the present disclosure is not limited to this design and it is contemplated that the sign system 100 could be configured to house a docking station 175 at other locations. In one embodiment, the carrier 170 may further be affixed to an identification badge 165. This holds potential for ensuring only authorized individuals have the ability to manipulate the sign system 100.

In one embodiment, the docking station 175 may comprise a “v” or other shape. The magnet 165 and/or the carrier 170 may be configured so as to have the same shape as the docking station 175. The particular shape of the magnet 165 and/or carrier 170 may provide a further security measure.

The present disclosure also provides for a method for providing at least one patient indication. In one embodiment, the method may comprise moving one or more notification panels comprising at least one patient indication so as to be visible or not visible within a one or more viewing windows of a sign system. Each patient indication may comprise at least one of: a word, a phrase, a color, and a symbol. Each patient indication may be further associated with at least one of: a medical condition, a patient need, a restriction, and a warning. In one embodiment, in which the notification panels comprise a ferrous material, the method may further comprise moving the notification panels using a magnet.

The present disclosure contemplates various methods for moving the notification panels using a magnet. One embodiment may comprise affixing a magnet to the front of the sign system. The magnet may then be manipulated by an authorized user to move the notification panels. Another embodiment may comprise inserting a magnet into a docking station. The magnet may then be manipulated by an authorized user to move the notification panels. To ensure the sign system is tamper-resistant, the method may comprise housing the magnet within a carrier and further affixing the carrier to an identification badge. This ensures only authorized individuals can manipulate the sign system and provide patient indications.

While the disclosure has been described in detail in reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they conic within the scope of the appended claims and their equivalents.

What is claimed is:

1. A sign system comprising:
at least one support panel configured for affixing the sign system to a surface;
at least one viewing panel comprising at least one viewing window;
a means for defining at least one channel between the support panel and the viewing panel;
at least one notification panel, wherein each notification panel comprises at least one patient indication and wherein each notification panel is configured to be movable within the channel so as to be visible or not visible within the viewing window.

2. The sign system of claim 1 further comprising at least one lens affixed to the viewing panel.

3. The sign system of claim 1 farther comprising at least one magnet configured for moving the notification panel within a channel.

4. The sign system of claim 3 wherein the magnet is further housed within a carrier.

5. The sign system of claim 1 wherein the notification panel further comprises at least one ferrous material.

6. The sign system of claim 1 wherein the patient indication further comprises at least one of: a word, a phrase, a color, and a symbol.

7. The sign system of claim 1 wherein the patient indication is further associated with at least one of: a medical condition, a patient need, a restriction, and a warning.

8. The sign system of claim 1 further comprising a means for creating a docking station between the support panel and a surface.

9. The sign system of claim 8 wherein the display panel is further configured to be movable by inserting a magnet into the docking station.

10. The sign system of claim 4 wherein the carrier is further affixed to an identification badge.

11. A sign system comprising:
at least one support panel configured for affixing the sign system to a surface;
at least one viewing panel comprising at least one viewing window;
a means for defining at least one channel between the support panel and the viewing panel;
at least one notification panel comprising a ferrous material, wherein each notification panel comprises at least one patient indication, and wherein each notification panel is configured to be movable within a channel so as to be visible or not visible within the viewing window; and
at least one magnet configured for moving the display panel within the channel.

12. The sign system of claim 11 wherein the magnet is further housed within a carrier.

13. The sign system of claim 11 wherein the patient indication further comprises at least one of: a word, a phrase, a color, and a symbol.

14. The sign system of claim 11 wherein the patient indication is further associated with at least one of: a medical condition, a patient need, a restriction, and a warning.

15. The sign system of claim 11 further comprising a means for creating a docking station between the support panel and a surface.

16. The sign system of claim 15 wherein the display panel is further configured to be movable by inserting a magnet into the docking station.

17. The sign system of claim 12 wherein the carrier is further affixed to an identification badge.

18. A method for providing at least one patient indication comprising:
moving a notification panel comprising at least one patient indication so as to be visible or not visible within a viewing window of a display device.

19. The method of claim 18 wherein the notification panel further comprises a ferrous material.

20. The method of claim 19 wherein moving the notification panel is further achieved using a magnet.

21. The method of claim 20 wherein moving the notification panel is further achieved by inserting a magnet into a docking station.

22. The method of claim 20 wherein the magnet is further housed within a carrier, further comprising affixing the carrier to an identification badge.

23. The method of claim 18 wherein the patient indicator further comprises at least one of: a word, a phrase, a color, and a symbol.

24. The method of claim 18 wherein the patient indicator is further associated with at least one of a medical condition, a patient need, a restriction, and a warning.
